(19) United States
(12) Patent Application Publication
(10) Pub. No.: US 2025/0379388 A1
(43) Pub. Date: Dec. 11, 2025

(54) Power Adapter and Power Adaption Device

(71) Applicant: Anker Innovations Technology Co.,, Changsha (CN)

(72) Inventors: Qingqing Wu, Shenzhen (CN); Tao Chen, shenzhen (CN)

(21) Appl. No.: 19/227,039

(22) Filed: Jun. 3, 2025

(30) Foreign Application Priority Data
Jun. 5, 2024 (CN) 202421279155.9

(51) Int. Cl. H01R 13/453; H01R 13/02; H01R 13/10; H01R 13/502; H01R 103/00

(52) U.S. Cl. CPC H01R 13/4538; H01R 13/025; H01R 13/10; H01R 13/4532; H01R 13/502; H01R 2103/00

(57) ABSTRACT

Aspects described herein relate to a power adaptor and a power adaption device. The power adaptor may comprise a housing comprising jacks, a conductive assembly comprising a first and second conductive portion, and a protection assembly. The protection assembly may comprise an insulation barrier. When the insulation barrier is in a protection position, the insulation barrier is located between the first conductive portion and the jacks, and when the insulation barrier is in a conducted position, the first conductive portion is exposed. When inserted into the jacks, the pins push the insulation barrier to move from the protection position to the conducted position. The pins may, when inserted into the jacks, contact and drive the insulation barrier to move from the protection position to the conducted position. In this manner, the pins may contact the first conductive portion when a plug is inserted into the jacks.

### CROSS-REFERENCE TO RELATED APPLICATION

The present application claims priority to Chinese Patent Application No. 202421279155.9, filed on Jun. 5, 2024, which is herein incorporated by reference by its entirety.

### FIELD

The present disclosure relates to the technical field of power adapters, such as a power adapter and a power adaption device.

### BACKGROUND

A socket adapter may be provided on a power cord. When the socket adapter on the power cord is disconnected from a plug of an external electronic device, since the power cord may still be in contact with a wall socket, the socket adapter on the power cord might be exposed outside, and an object (e.g., a child's finger, a small hardware structure) may be inserted into an L/N pole jack on the socket adapter. This is dangerous: it might induce a current to form a loop in a human body, which may cause a user to get an electric shock.

### SUMMARY

Aspects described herein relate to a power adapter and/or a power adaption device which may reduce a probability that a user gets an electric shock due to mis-insertion.

For example, aspects described herein relate to a power adapter, including: a housing provided with an accommodation cavity and jacks communicating with the accommodation cavity, the jacks being configured for insertion of pins of a plug and a conductive assembly including a first conductive portion and a second conductive portion. The first conductive portion may be located inside the accommodation cavity and may be electrically connected to the second conductive portion. The first conductive portion may be configured to contact the pin, and the second conductive portion may be configured to be electrically connected to an external power cord. A protection assembly including an insulation barrier may be located inside the accommodation cavity, and that insulation barrier may be movably connected to the housing to be switched between a protection position in which the insulation barrier is located between the first conductive portion and the jacks to separate the first conductive portion from the jacks and a conducted position in which the first conductive portion is exposed to allow the pin to contact the first conductive portion through the jack, in which when the pins may be inserted into the accommodation cavity through the jacks at the same time. The pins may push the insulation barrier to move from the protection position to the conducted position, and/or the pins may contact the first conductive portion.

Aspects described herein further relate to a power adaption device, including: the power adapter as described above, in which the housing including a bump and/or the jacks may be provided on the bump. The power adaption device may further comprise a plug including pins and provided with a groove for accommodating the bump. The pins may be connected to a bottom wall of the groove. The bump may be located inside the groove. In this circumstance, the pins may be inserted into the jacks.

There may be many benefits to the present disclosure, including but not limited to: the insulation barrier may be provided between the first conductive portion and the jacks to shield the jacks, at which time a user's finger may be obstructed by the insulation barrier when inserted into the jack so that the finger cannot touch the first conductive portion and get an electric shock due to mis-insertion, thereby reducing a possibility that a user directly contacts the first conductive portion through the jacks when the plug is not inserted into the jacks can be reduced, and reducing a probability that the user may receive an electric shock due to mis-insertion. Moreover, when the plug in the example is inserted into the jacks, a plurality of the pins of the plug may be inserted into the jacks at the same time, may contact the insulation barrier, and may drive the insulation barrier to move. At this time, the insulation barrier may move from the protection position to the conducted position, so that the pins might normally contact the first conductive portion after the plug is inserted into the jacks, and an external power supply may be electrically connected to an electronic device through the power adaptor while preventing the user from an electric shock due to mis-insertion, ensuring that the external power supply may normally supply power to the electronic device.

### BRIEF DESCRIPTION OF THE DRAWINGS

Drawings used in description of the examples or the related art may be briefly introduced below. The drawings are merely some examples of the disclosure.

FIG. 1 is a structure diagram of a power adapter and a plug;

FIG. 2 is an exploded structure diagram of a power adapter and a plug;

FIG. 3 is an exploded structure diagram of a power adapter;

FIG. 4 is a structure diagram of a conductive assembly and a protection assembly;

FIG. 5 is an exploded structure diagram of a power adapter;

FIG. 6 is a structure diagram of part of a power adapter;

FIG. 7 is a cross-sectional structure diagram of a conductive assembly and a protection assembly;

FIG. 8 is a structure diagram of an insulation barrier;

FIG. 9 is a force diagram of a first obstruction portion and a second obstruction portion;

FIG. 10 is a structure diagram of pins, a conductive assembly and a protection assembly;

FIG. 11 is a structure diagram of an insulation barrier;

FIG. 12 is a cross-sectional structure diagram of a power adaption device; and

FIG. 13 is a structure diagram of a power adaption device.

Reference numerals: 1 power adapter; 10 housing; 11 jack; 12 guide rail; 13 bump; 14 upper cover; 15 lower cover; 16 outer housing; 20 conductive assembly; 21 clamping portion; 22 cantilever; 23 live wire; 24 neutral wire; 25 ground wire; 26 first conductive portion; 27 second conductive portion; 30 protection assembly; 31 insulation barrier; 311 guide slot; 312 rotary shaft; 313 first obstruction portion; 3131 first side surface; 314 second obstruction portion; 3141 second side surface; 315 first limit slot; 316 second limit slot; 32 first restoration member; L1 first direction; L2 second direction; 2 plug; 41 pin; 42 groove; 3 power adaption device; 4 power cord.

### DETAILED DESCRIPTION

The present disclosure may be described below with reference to the accompanying drawings. The described examples may be a part, but not all, of the examples of the present disclosure, and other examples may be within the scope of the present disclosure.

As indicated above, many conventional jacks of a socket may be exposed outside, such that an object (e.g., a child's finger or a small hardware structure) might be inserted into the jacks and thereby cause an electric shock accident.

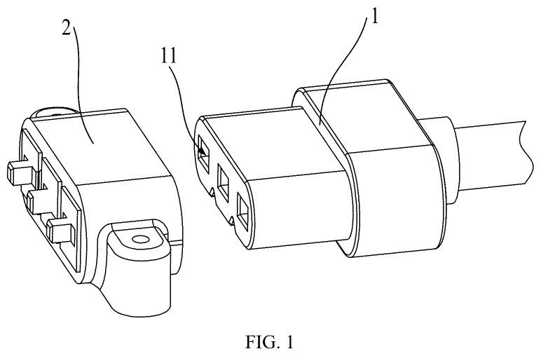

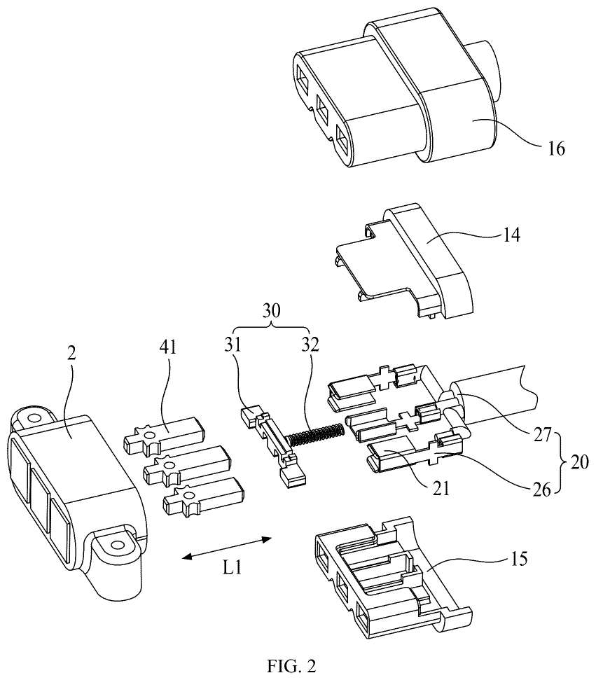

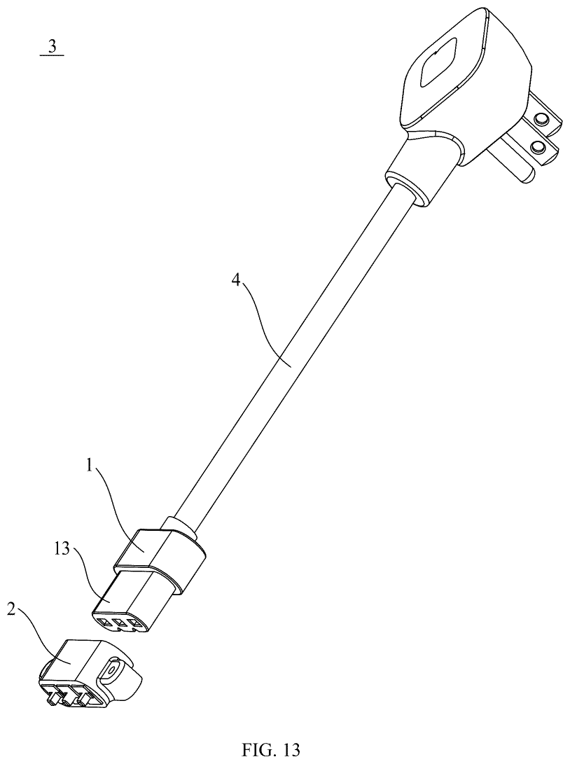

FIG. 1 to FIG. 3 relate to a power adapter 1 including a housing 10, a conductive assembly 20 and a protection assembly 30. The housing 10 may be provided with an accommodation cavity (not shown in the drawings) and jacks 11 communicating with the accommodation cavity, and the jacks 11 may be configured for insertion of pins 41 of a plug 2. As shown in FIG. 2, the conductive assembly 20 may include a first conductive portion 26 and a second conductive portion 27. The first conductive portion 26 may be located inside the accommodation cavity and may be configured to contact the pins 41. One part of the second conductive portion 27 may be located inside the accommodation cavity and may be electrically connected to the first conductive portion 26, and the other part of the second conductive portion 27 may extend out of the accommodation cavity to be electrically connected to an external power cord 4 (as shown in FIG. 13), so that after the pins 41 of the plug 2 may be inserted into the jacks 11, the pins 41 might be electrically connected to the first conductive portion 26, and the plug 2 is electrically connected to the external power cord 4 through the power adapter 1. This may achieve energization between the plug 2 and the external power supply. The housing 10 may include an upper cover 14 and a lower cover 15 detachably connected and enclosing the accommodation cavity. The lower cover 15 may be provided with an installation cavity inside which the first conductive portion 26 is fixed, so as to limit the conductive assembly 20.

The protection assembly 30 includes an insulation barrier 31 located inside the accommodation cavity. The insulation barrier 31 is movably connected to the housing 10, and the insulation barrier 31 is movable relative to the housing 10 to be switched between a protection position in which the insulation barrier 31 is located between the first conductive portion 26 and the jacks 11 to separate the first conductive portion 26 from the jacks 11 so as to shield the jacks 11 and a conducted position. When the pins 41 are inserted into the accommodation cavity through the jacks 11, the pins 41 may push the insulation barrier 31 to move from the protection position to the conducted position. At this time, the first conductive portion 26 may be exposed, and the pins 41 might be able to pass through the jacks 11 to contact the first conductive portion 26 and conduct electricity.

The insulation barrier 31 may be made of an insulation material and may be configured to isolate the first conductive portion 26. The insulation barrier 31 may have has high insulating performance. The insulation barrier 31 can directly contact a live part on the first conductive portion 26 to play a temporary shielding role. The insulation barrier 31 may be slidably connected and/or rotatably connected to the housing 10.

The insulation barrier 31 may be provided between the first conductive portion 26 and the jacks 11 to, e.g., shield the jacks 11. In this manner, a user's finger might be obstructed by the insulation barrier 31 when inserted into the jacks 11, and the finger might not be able to touch the first conductive portion 26 and receive an electric shock due to mis-insertion, thereby reducing the probability that the user receives an electric shock due to mis-insertion. When the plug 2 is inserted into the power adapter 1, the pins 41 of the plug 2 may be inserted into the jacks 11, and might contact the insulation barrier 31 and drive the insulation barrier 31 to move. The insulation barrier 31 may move from the protection position to the conducted position, so that the pins 41 might normally contact the first conductive portion 26 after the plug 2 is inserted into the jacks 11, thereby potentially ensuring that the plug 2 on the electronic device can be normally connected to the external power cord 4 through the power adapter 1 while potentially preventing the user from an electric shock due to mis-insertion.

As shown in FIG. 2 to FIG. 4, there may be a plurality of jacks 11, and the first conductive portion 26 may include clamping portions 21 provided in, for example, one-to-one correspondence with a plurality of the jacks 11. After a plurality of the pins 41 may be inserted into the jacks 11, each of the pin 41 may be clamped by the clamping portion 21, thereby potentially reducing a shaking of the pins 41 and potentially ensuring that a plurality of the pins 41 can stably contact the clamping portions 21 and conduct electricity.

The clamping portion 21 may include a conductive elastic sheet. After a plurality of the pins 41 penetrate through the jacks 11, the pins 41 may be inserted into the clamping portions 21. The pins 41 may exert an action force on the conductive elastic sheet, and the conductive elastic sheet may be deformed to clamp the pins 41, and therefore the pins 41 may be in close contact with the conductive elastic sheet, potentially reducing the possibility of looseness of the pins 41, and potentially improving the reliability of the electrical connection between the pins 41 and the first conductive portion 26. A guiding slope may be provided at an end of the clamping portion 21 facing the jacks 11. During the process of inserting the pins 41 into the clamping portion 21, ends of the pins 41 might first contact the guiding slope and might slide along the guiding slope until entering the clamping portion 21. The guiding slope may provide a guiding effect for the pins 41.

Referring to FIG. 2 to FIG. 4, in some examples of the present disclosure, the insulation barrier 31 is slidably connected to the housing 10 along a first direction L1, and the first direction L1 is parallel to axial directions of the jacks 1. The first conductive portion 26 may have a placement space (not shown in the drawings) configured to accommodate the insulation barrier 31 and the pins 41. The insulation barrier 31 may slide in the placement space along the first direction L1, where the placement space extends along the first direction L1 to provide a sliding space for the insulation barrier 31.

The pins 41 may be inserted into the jacks 11 along the first direction L1, and then the ends of the pins 41 might contact the insulation barrier 31 and may push the insulation barrier 31 to slide along the first direction L1 inside the placement space until the pins 41 enter the placement space, contact the first conductive portion 26, and/or conduct electricity. An inner side wall of the first conductive portion 26 may encloses the placement space, and the pins 41 may contact the inner side wall of the first conductive portion 26 inside the placement space. A peripheral side of the insulation barrier 31 might also contacts the inner side wall of the first conductive portion 26. The placement space may provide a sliding space for the insulation barrier 31, and the inner side wall of the first conductive portion 26 may provide a limit for the insulation barrier 31 to prevent the insulation barrier 31 from shifting and/or misalignment during the sliding process.

A plurality of the jacks 11 might be arranged at intervals evenly when the plug 2 has a plurality of the pins 41. When the plug 2 is inserted into the housing 10, a plurality of the pins 41 might be inserted into the jacks 11 at the same time, and might contact the insulation barrier 31 at the same time and/or push the insulation barrier 31 to slide inside the placement space along the first direction L1. For example, the plug 2 may include two pins 41 and the housing 10 may include two jacks 11. The two jacks 11 may be arranged in parallel at intervals along a second direction L2 perpendicular to the first direction L1. When an object (e.g., a child inserts a finger or a small hardware structure) is inserted through a single-sided jack 11, the insulation barrier 31 may be subjected to force at a single side. At this time, the insulation barrier 31 may tilt due to the unbalanced force. In this way, a sliding direction of the insulation barrier 31 may be provided at an angle with an extension direction of the guide rail 12, and the peripheral side of the insulation barrier 31 may be squeezed by the inner side wall of the first conductive portion 26. The inner side wall of the first conductive portion 26 may hinder the tilt of the insulation barrier 31, making it difficult for the insulation barrier 31 to slide along the first direction L1 inside the placement space, thereby reducing the probability that a foreign object is inserted through the single-sided jacks 11 and contacts the first conductive portion 26. For example, the plug 2 may include three pins 41 and the housing 10 has three jacks 11. The three jacks 11 may be evenly arranged at intervals, and the conductive assembly includes a ground wire 25 corresponding to the middle jack 11. Even if the foreign object is inserted into the middle jack 11 and pushes the insulation barrier 31 to slide along the first direction, the foreign object may contact the first conductive portion 26. However, since the ground wire 25 is not live, no electric shock accident might occur even if the foreign object contacts the first conductive portion 26.

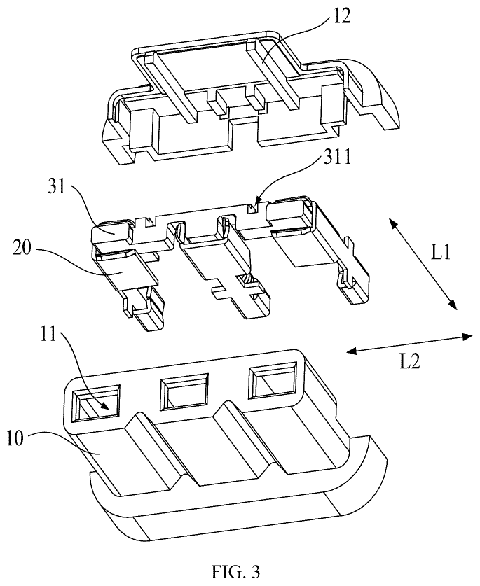

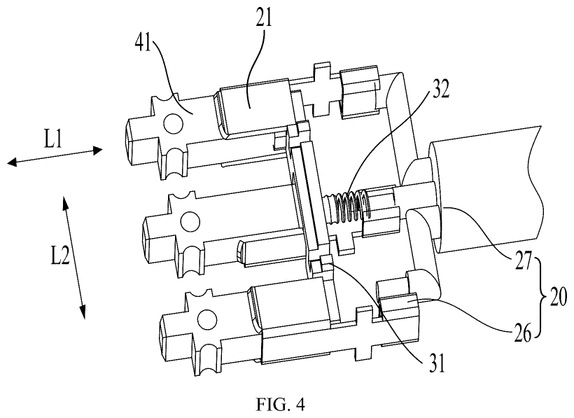

Further, referring to FIG. 3 to FIG. 4, a guide rail 12 extending along the first direction L1 may be provided on the housing 10, and a guide slot 311 may be provided on the insulation barrier 31. The insulation barrier 31 may be slidably connected to the guide rail 12 through the guide slot 311. The guide rail 12 may provide a guiding function for the insulation barrier 31 along the first direction L1 to prevent the insulation barrier 31 from shifting or misalignment during the sliding process.

For example, the plug 2 may include two pins 41 and the housing 10 has two jacks 11. In this example, the two jacks 11 may be arranged in parallel at intervals along the second direction L2. When the insulation barrier 31 is subjected to a balanced force, an extension direction of the guide slot 311 may be parallel to the first direction L1. When, for example, a child inserts a finger or a fine hardware structure through one single-sided jack 11, the insulation barrier 31 may be subjected to force at a single side. At this time, the insulation barrier 31 may tilt due to unbalanced force, and a direction of the guide slot 311 on the insulation barrier 31 may also tilt, for instance, the extension direction of the guide slot 311 may be provided at an angle with an extension direction of the guide rail 12. In such an illustrative circumstance, it may be difficult for the guide slot 311 to slide relative to the guide rail 12 along the first direction L1, e.g., the slot wall of the guide slot 311 might be squeezed by the guide rail 12, thereby hindering the insulation barrier 31 from sliding along the first direction L1 inside the placement space. This may reduce the probability that a foreign object is inserted through the single-sided jack 11 and contacts the first conductive portion 26.

Exemplarily, as shown in FIG. 3, a plurality of guide rails 12 arranged in parallel along the second direction L2 may be provided at the upper cover 14 of the housing 10, and guide slots 311 corresponding to a plurality of the guide rails 12 may be provided on the insulation barrier 31. When the insulation barrier 31 tilts, some or all of the extension directions of a plurality of the guide slots 311 may be provided at an angle with the first direction L1, for instance, the extension directions of the guide rails 12 may be at an angle with the extension directions of the guide slots 311. Therefore, it may be difficult for the insulation barrier 31 to slide along the extension direction of the guide rails 12, thereby further reducing the probability that the foreign object is inserted through the single-side jack 11 and contacts the first conductive portion 26.

Further, referring to FIG. 2 and FIG. 4, the protection assembly 30 may further include a first restoration member 32 may be connected to the insulation barrier 31 and the housing 10, and may be configured to restore the insulation barrier 31 to the protection position. The first restoration member 32 may comprise a spring.

When the pins 41 may be just inserted into the jacks 11, the pins 41 may push the insulation barrier 31 to slide from the protection position to the conducted position along the first direction L1, and the first restoration member 32 may be elastically deformed. After the pins 41 are fully inserted into the jacks 11, the insulation barrier 31 may be located at the conducted position under the action of the pins 41. When the pins 41 leave the jacks 11, the insulation barrier 31 might lose the external force of the pins 41, and elastic force of the first restoration member 32 may push the insulation barrier 31 to slide from the conducted position to the protection position.

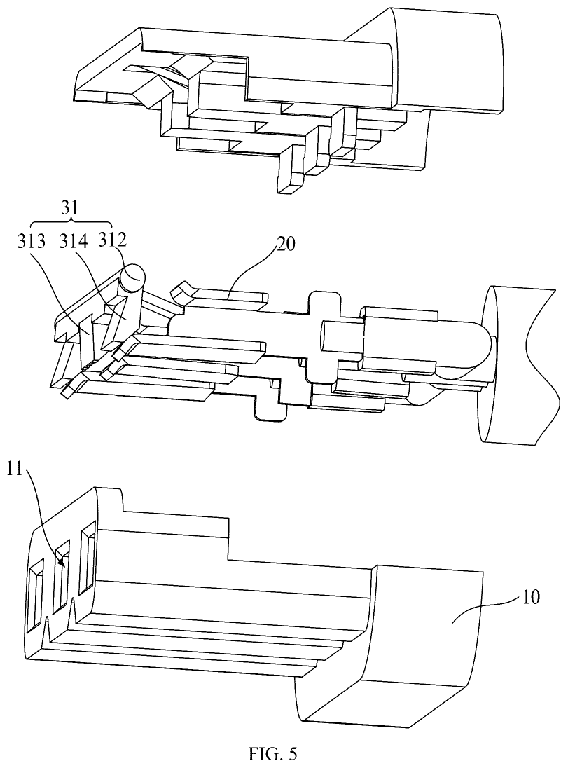

Referring to FIG. 5, there may be a plurality of jacks 11, and the insulation barrier 31 may include a rotary shaft 312, a first obstruction portion 313, and/or two second obstruction portions 314. The rotary shaft 312 may be rotatably connected to the housing 10 around an axis of the rotary shaft 312, and an extension direction of the axis of the rotary shaft 312 may be perpendicular to an axial direction of the jack 11. The first obstruction portion 313 may be located between the two second obstruction portions 314. Each of the first obstruction portion 313 and the second obstruction portions 314 may be provided with a fixed end and a free end that may be provided opposite, the fixed end may be connected to the rotary shaft 312, and each of the free ends of the first obstruction portion 313 and the second obstruction portion 314 may correspond to one jack 11.

For instance, when the plug 2 is not inserted into the jacks 11, each of the obstruction portions may shield one jack 11. When the plug 2 is inserted into the housing 10, an end of each of the pins 41 may contact the free end of the obstruction portion, and the free end of the obstruction portion may be pushed to rotate around the axis of the rotary shaft 312 to expose the jack 11 and potentially avoid the placement space at the first conductive portion 26, so that the pins 41 might continue to be inserted until the pins 41 may be fully inserted into the jacks 11 and contact the first conductive portion 26 to conduct electricity.

As shown in FIG. 6, a snap-fit slot may be provided between the first obstruction portion 313 and the second obstruction portion 314, and two snap-fit portions may be provided at the lower cover 15 of the housing 10. When the insulation barrier 31 is at the protection position, each of the snap-fit portions might fit one of the snap-fit slots, so that the insulation barrier 31 may be provided more stable, and the first obstruction portion 313 or the second obstruction portion 314 may be prevented from tilting when shielding the jacks 11.

The protection assembly 30 may further include a second restoration member (not shown in the drawings) connected to the insulation barrier 31 and the housing 10, and the protection assembly 30 may be configured to restore the insulation barrier 31 to the protection position. The second restoration member might comprise, for example, a torsion spring.

When the pins 41 are just inserted into the jacks 11, the pins 41 may push the first obstruction portion 313 and/or the second obstruction portion 314, and may cause the obstruction portions to rotate around the axis of the rotary shaft 312. This may cause the second restoration member to be elastically deformed. After the pins 41 may be fully inserted into the jacks 11, the insulation barrier 31 may be located at the conducted position under the action of the pins 41. When the pins 41 leave the jacks 11, the first obstruction portion 313 and the second obstruction portions 314 might lose the external force of the pins 41, and elastic force of the second restoration member 32 might dive the rotary shaft 312 to rotate, so that the insulation barrier 31 rotates from the conducted position to the protection position.

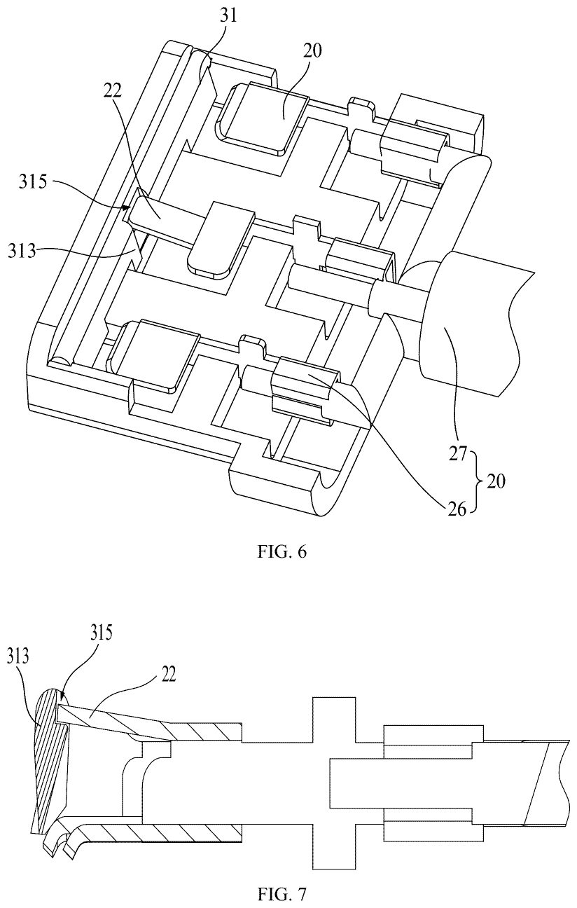

Referring to FIG. 6 and FIG. 7, the first conductive portion 26 might include a cantilever 22 provided toward the rotary shaft 312, and a first limit slot 315 may be provided at a side of the first obstruction portion 313 close to the rotary shaft 312. The cantilever 22 may be an elastic member. When the insulation barrier 31 is in the protection position, the cantilever 22 may be clamped inside the first limit slot 315 and the first limit slot 315 may provide a limiting function for the cantilever 22. When clamped inside the first limit slot 315, the cantilever 22 might provide the insulation barrier 31 with an acting force away from the first conductive portion 26 and perpendicular to an axis direction of the jack 11, thereby potentially preventing the insulation barrier 31 from shaking at the protection position.

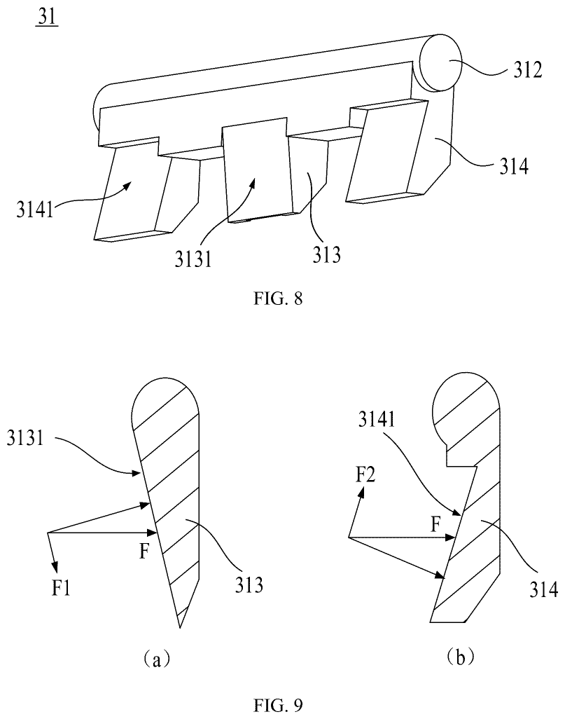

As shown in FIG. 7 and FIG. 8, the first obstruction portion 313 may have a first side surface 3131 provided facing the jack 11, and the second obstruction portion 314 may have a second side surface 3141 provided facing the jack 11. Both a fixed side of the first side surface 3131 and a fixed side of the second side surface 3141 may be connected to the rotary shaft 312, a free side of the first side surface 3131 may be inclined in a direction away from the jack 11, and a free side of the second side surface 3141 may be inclined in a direction close to the jacks 11, that is, inclination directions of the first side surface 3131 and the second side surface 3141 may be provided at an angle. When the insulation barrier 31 is in the protection position, the cantilever 22 may be located inside the first limit slot 315, and the first side surface 3131 and the second side surface 3141 shield the jacks 11. When the insulation barrier 31 rotates to the conducted position, the cantilever 22 may leave the first limit slot 315, and the first side surface 3131 and the second side surface 3141 might expose the jacks 11, which avoids the placement space at the first conductive portion 26 to facilitate the insertion of the pins 41.

For example, the cantilever 22 may be located inside the first limit slot 315, and an end of the cantilever 22 may contact a side wall of the first limit slot 315. As shown in FIG. 9 (a), when the pins 41 push the first obstruction portion 313, the end of the pin 41 may exert a force F on the first side surface 3131, and the first side surface 3131 may be inclined in a direction away from the jacks 11. Therefore, the force F exerted by the pins 41 on the first side surface 3131 may have a first component force F1 away from the rotary shaft 312, which may be prone to push the first obstruction portion 313 to rotate in a direction close to the first conductive portion 26, so that the cantilever 22 leaves the first limit slot 315 and the insulation barrier 31 rotates to the conducted position.

As shown in FIG. 9 (b), when an object (such as a child's finger or a small hardware structure) is inserted through one or two jacks 11 corresponding to the second obstruction portions 314, an end of the foreign object may exert a force F on the second side surface 3141, and the second side surface 3141 may be inclined toward the direction close to the jacks 11. In this manner, the force F exerted by the foreign object on the second side surface 3141 may have a second component force F2 toward the rotary shaft 312. The action of the second component force F2 may generate interference between the side wall of the first limit slot 315 and the cantilever 22, thereby hindering the rotation of the insulation barrier 31. It may be difficult for the insulation barrier 31 to rotate around the axis of the rotary shaft 312, thereby potentially reducing the probability that a foreign object is inserted through the jacks 11 corresponding to the second obstruction portions 314 and contacts the first conductive portion 26.

Since a length of the pin 41 in the middle of the plug 2 might be larger than a length of the pins 41 on both sides, when the plug 2 is inserted into the housing 10, the pins 41 in the middle can first push the insulation barrier 31 to rotate to expose a placement space at the first conductive portion 26, so that the pins 41 on both sides might be smoothly inserted into the jacks 11 and contact the first conductive portion 26.

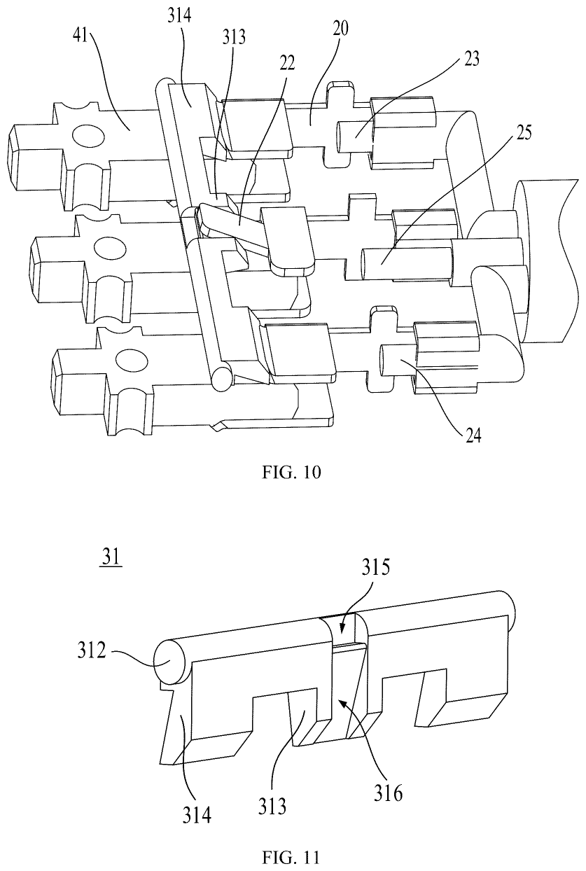

Further, referring to FIG. 10, the first conductive portion 26 may include a live wire 23, a neutral wire 24 and/or a ground wire 25. The ground wire 25 may be located between the live wire 23 and the neutral wire 24 and may be provided corresponding to the first obstruction portion 313. The live wire 23 and the neutral wire 24 may be provided corresponding to the second obstruction portions 314. The live wire 23, the neutral wire 24, and/or the ground wire 25 may be configured to contact the pins 41. An object may be inserted into the jack 11 corresponding to the first obstruction portion 313, for example, the object may be inserted into the jack 11 located in the middle, and the foreign object may push the insulation barrier 31 to rotate so that the foreign object contacts the first conductive portion 26. However, since the ground wire 25 is not charged, no electric shock accident might occur even if the foreign object contacts the first conductive portion 26.

All of the live wire 23, the neutral wire 24, and/or the ground wire 25 may be electrically connected to the clamping portion 21, the live wire 23, and/or the clamping portion 21 together may form an L pole of the power adapter 1, the neutral wire 24 and the clamping portion 21 together may form an N pole of the power adapter 1, and the ground wire 25 and the clamping portion 21 together may form an E pole of the power adapter 1.

Further, referring to FIG. 11, a second limit slot 316 may be provided on a side of the first obstruction portion 313 away from the first side surface 3131. When the insulation barrier 31 rotates from the protection position to the conducted position, the cantilever 22 might leaves the first limit slot 315 and may enter the second limit slot 316, and a width of the first limit slot 316 along the axial direction of the rotary shaft 312 may be greater than a width of the cantilever 22 along the axial direction of the rotary shaft 312. When the cantilever 22 is located inside the second limit slot 316, a side wall of the cantilever 22 may contact a side wall of the second limit slot 316, so that the second limit slot 316 may provide a limiting effect for the cantilever 22 to prevent the cantilever 22 from shifting or misalignment during the rotation of the insulation barrier 31, and the second limit slot 316 might also reduce the shaking of the cantilever 22. When the cantilever 22 is clamped inside the second limit slot 316, the free end of the first obstruction portion 313 may be sandwiched between the cantilever 22 and the pins 41, thereby potentially preventing the insulation barrier 31 from shaking at the conducted position.

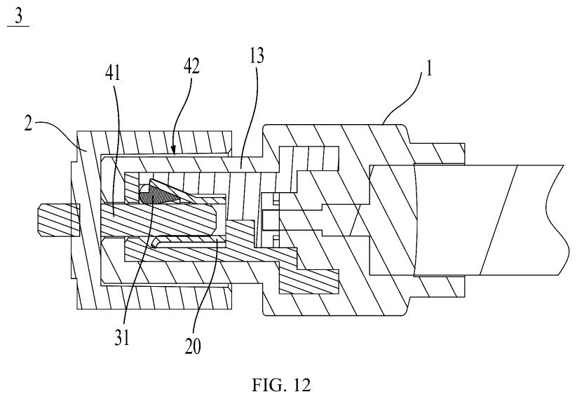

FIG. 12 and FIG. 13 relate to a power adaption device 3 including a plug 2 and the power adapter 1 as described above, in which the plug 2 may include pins 41, and the pins 41 may be inserted in the jacks 11.

The power adaption device 3 may comprise a male plug and/or a female adapter. The male plug may be a plug 2 for adaption and might be electrically connected to an electronic device, and the female adapter may be a power adapter 1 for adaption and might be electrically connected to a power cord 4, so that the electronic device can be electrically connected to different power supplies through the female adapter.

Referring to FIG. 12 and FIG. 13, the housing 10 may include a bump 13 on which the jacks 11 may be provided, the plug 2 may be provided with a groove 42 for accommodating the bump 13, and the pins 41 may be connected to the bottom wall of the groove 42. The pins 41 may be inserted into the jacks 11 when the bump 13 is inside the groove 42.

For example, the housing 10 may comprise an outer housing 16 (as shown in FIG. 2). The outer housing 16 may be wrapped around the outer side of the upper cover 14 and the lower cover 15 to provide protection and buffering for components such as the first conductive portion 26 inside the accommodation cavity. Part of the outer housing 16 may form the bump 13, and the first conductive portion 26 and the protection assembly 30 may be located inside the bump 13. The groove 42 may provide an assembly space for the bump 13, and an inner side wall of the groove 42 may contact the bump 13, which may provide support for the bump 13 and/or may reduce shaking when the plug 2 is connected to the power adapter 1. This may improve a stability of the electrical connection between the plug 2 and the power adapter 1.

The same or similar reference numerals in the drawings of the examples of the present disclosure correspond to the same or similar parts. In the description of the present disclosure, the terms “upper”, “lower”, “left”, “right”, and the like indicating relationships of directions and positions may be based on relationships of directions and positions shown in the drawings, and are illustrative and simplify descriptions only. Such terms are for illustrative purposes only and do not indicate or imply that the referred assembly or element must be provided, configured, and/or operated in a particular direction.

The above discussion provides illustrative examples of the present disclosure and does not limit the present disclosure. Any modifications, equivalent substitutions, and/or improvements made within the spirit and principle of the present disclosure should be included in the protection scope of the present disclosure.

What is claimed is:

1. A power adapter comprising:
a housing comprising:
an accommodation cavity, and
one or more jacks configured to receive one or more pins of a plug;
a conductive assembly comprising:
a first conductive portion, and
a second conductive portion, wherein the first conductive portion is located inside the accommodation cavity and electrically connected to the second conductive portion, wherein the first conductive portion is configured to contact the one or more pins, and wherein the second conductive portion is configured to be electrically connected to an external power cord; and
a protection assembly comprising an insulation barrier located inside the accommodation cavity, wherein the insulation barrier is movably connected to the housing to be switched between:
a protection position in which the insulation barrier is located between the first conductive portion and the one or more jacks to separate the first conductive portion from the one or more jacks, and
a conducted position in which the first conductive portion is exposed to allow the one or more pins to contact the first conductive portion through the one or more jacks.

2. The power adapter according to claim 1,
wherein the insulation barrier is slidably connected to the housing along a first direction parallel to an axial direction of the one or more jacks; and
wherein the first conductive portion has a placement space configured to accommodate the insulation barrier and the one or more pins, and
wherein the insulation barrier slides in the placement space along the first direction.

3. The power adapter according to claim 1, wherein the insulation barrier is slidably connected, via a guide rail, to the housing.

4. The power adapter according to claim 1, wherein the protection assembly further comprises a first restoration member connected to the insulation barrier and the housing, and wherein the first restoration member is configured to restore the insulation barrier to the protection position.

5. The power adapter according to claim 1, wherein:
the insulation barrier comprises a rotary shaft, a first obstruction portion, and two second obstruction portions,
the rotary shaft is rotatably connected to the housing around an axis of the rotary shaft,
an extension direction of the axis of the rotary shaft is perpendicular to an axial direction of the one or more jacks,
the first obstruction portion is located between the two second obstruction portions, and
each of the first obstruction portion and the second obstruction portions is connected to the rotary shaft and is associated with at least one of the one or more jacks.

6. The power adapter according to claim 1, wherein:
the insulation barrier comprises a rotary shaft, a first obstruction portion, and two second obstruction portions,
the first conductive portion comprises a cantilever provided toward the rotary shaft,
a first limit slot is provided at a side of the first obstruction portion close to the rotary shaft,
the first obstruction portion has a first side surface provided facing the one or more jacks,
the second obstruction portion has a second side surface provided facing the one or more jacks,
both a fixed side of the first side surface and a fixed side of the second side surface are connected to the rotary shaft,
a free side of the first side surface is inclined in a direction away from the one or more jacks,
a free side of the second side surface is inclined in a direction close to the one or more jacks,
when the insulation barrier is in the protection position, the cantilever is located inside the first limit slot, and the first side surface and the second side surface shield the one or more jacks, and
when the insulation barrier rotates to the conducted position, the cantilever leaves the first limit slot, and the first side surface and the second side surface expose the one or more jacks.

7. The power adapter according to claim 1, wherein:
the insulation barrier comprises a rotary shaft, a first obstruction portion, and two second obstruction portions,
the first conductive portion comprises a cantilever provided toward the rotary shaft,
a first limit slot is provided at a side of the first obstruction portion close to the rotary shaft,
the first obstruction portion has a first side surface provided facing the one or more jacks,
a second limit slot is provided on a side of the first obstruction portion away from the first side surface, and
when the insulation barrier rotates from the protection position to the conducted position, the cantilever leaves the first limit slot and enters the second limit slot.

8. The power adapter according to claim 1, wherein:
the insulation barrier comprises a first obstruction portion and two second obstruction portions,
the first conductive portion comprises a live wire, a neutral wire and a ground wire,
the ground wire is located between the live wire and the neutral wire and corresponds to the first obstruction portion,
the live wire and the neutral wire correspond to the second obstruction portions, and
the live wire, the neutral wire, and the ground wire are configured to contact the one or more pins.

9. The power adapter according to claim 1, wherein:
the first conductive portion comprises one or more clamping portions provided in one-to-one correspondence with the one or more jacks, and
the one or more clamping portions are configured to clamp the one or more pins.

10. The power adapter according to claim 1, wherein, when inserted into the accommodation cavity through the one or more jacks, the one or more pins are configured to push the insulation barrier to move from the protection position to the conducted position and contact the first conductive portion.

11. A power adaption device comprising:
a power adapter comprising:
a housing comprising:
an accommodation cavity, and
a bump comprising one or more jacks configured to receive one or more pins of a plug;
a conductive assembly comprising:
a first conductive portion, and
a second conductive portion, wherein the first conductive portion is located inside the accommodation cavity and electrically connected to the second conductive portion, wherein the first conductive portion is configured to contact the one or more pins, and wherein the second conductive portion is configured to be electrically connected to an external power cord; and
a protection assembly comprising an insulation barrier located inside the accommodation cavity, wherein the insulation barrier is movably connected to the housing to be switched between:
a protection position in which the insulation barrier is located between the first conductive portion and the one or more jacks to separate the first conductive portion from the one or more jacks, and
a conducted position in which the first conductive portion is exposed to allow the one or more pins to contact the first conductive portion through the one or more jacks; and
a plug comprising the one or more pins and provided with a groove for accommodating the bump, wherein the one or more pins being connected to a bottom wall of the groove, and wherein, when the bump is inside the groove, the one or more pins are configured to be inserted into the jacks.

12. The power adapter according to claim 11,
wherein the insulation barrier is slidably connected to the housing,
wherein the first conductive portion has a placement space configured to accommodate the insulation barrier and the one or more pins, and
wherein the insulation barrier slides in the placement space.

13. The power adapter according to claim 11, wherein the protection assembly further comprises a first restoration member connected to the insulation barrier and the housing, and wherein the first restoration member is configured to restore the insulation barrier to the protection position.

14. The power adapter according to claim 11, wherein:
the insulation barrier comprises a rotary shaft, a first obstruction portion, and two second obstruction portions,
the rotary shaft is rotatably connected to the housing around an axis of the rotary shaft,
an extension direction of the axis of the rotary shaft is perpendicular to an axial direction of the one or more jacks,
the first obstruction portion is located between the two second obstruction portions, and
each of the first obstruction portion and the second obstruction portions is connected to the rotary shaft and corresponds to at least one of the one or more jacks.

15. The power adapter according to claim 11, wherein:
the insulation barrier comprises a rotary shaft, a first obstruction portion, and two second obstruction portions,
the first conductive portion comprises a cantilever provided toward the rotary shaft,
a first limit slot is provided at a side of the first obstruction portion close to the rotary shaft,
the first obstruction portion has a first side surface provided facing the one or more jacks,
the second obstruction portion has a second side surface provided facing the one or more jacks,
both a fixed side of the first side surface and a fixed side of the second side surface are connected to the rotary shaft,
a free side of the first side surface is inclined in a direction away from the one or more jacks,
a free side of the second side surface is inclined in a direction close to the one or more jacks,
when the insulation barrier is in the protection position, the cantilever is located inside the first limit slot, and the first side surface and the second side surface shield the one or more jacks, and
when the insulation barrier rotates to the conducted position, the cantilever leaves the first limit slot, and the first side surface and the second side surface expose the one or more jacks.

16. The power adapter according to claim 11, wherein:
the insulation barrier comprises a rotary shaft, a first obstruction portion, and two second obstruction portions,
the first conductive portion comprises a cantilever provided toward the rotary shaft,
a first limit slot is provided at a side of the first obstruction portion close to the rotary shaft,
the first obstruction portion has a first side surface provided facing the one or more jacks,
a second limit slot is provided on a side of the first obstruction portion away from the first side surface, and
when the insulation barrier rotates from the protection position to the conducted position, the cantilever leaves the first limit slot and enters the second limit slot.

17. The power adapter according to claim 11, wherein:
the insulation barrier comprises a first obstruction portion and two second obstruction portions,
the first conductive portion comprises a live wire, a neutral wire and a ground wire,
the ground wire is located between the live wire and the neutral wire and corresponds to the first obstruction portion,
the live wire and the neutral wire correspond to the second obstruction portions, and
the live wire, the neutral wire, and the ground wire are configured to contact the one or more pins.

18. The power adapter according to claim 11, wherein:
the first conductive portion comprises one or more clamping portions provided in one-to-one correspondence with the one or more jacks, and
the one or more clamping portions are configured to clamp the one or more pins.

19. The power adapter according to claim 11, wherein, when inserted into the accommodation cavity through the one or more jacks, the one or more pins are configured to push the insulation barrier to move from the protection position to the conducted position and contact the first conductive portion.

20. A power adapter comprising:
a housing comprising one or more jacks configured to receive one or more pins of a plug;
a first conductive portion configured to contact the one or more pins;
a second conductive portion electrically connected to the second conductive portion and configured to be electrically connected to an external power cord; and
a protection assembly comprising an insulation barrier movably connected to the housing to be switched between:
a protection position in which the insulation barrier is located between the first conductive portion and the one or more jacks to separate the first conductive portion from the one or more jacks, and
a conducted position in which the first conductive portion is exposed to allow the one or more pins to contact the first conductive portion through the one or more jacks, wherein, when inserted through the one or more jacks, the one or more pins are configured to push the insulation barrier to move from the protection position to the conducted position and contact the first conductive portion.
